(19) United States
(12) Patent Application Publication
(10) Pub. No.: US 2012/0121083 A1
(43) Pub. Date: May 17, 2012

(54) ENCRYPTION APPARATUS AND METHOD

(75) Inventors: Yong-kuk YOU, Seoul (KR); Karen ISPIRYAN, Suwon-si (KR); Hee-jae PARK, Hwaseong-si (KR)

(73) Assignee: SAMSUNG ELECTRONICS CO., LTD., Suwon-si (KR)

(21) Appl. No.: 13/297,857

(22) Filed: Nov. 16, 2011

(30) Foreign Application Priority Data
Nov. 16, 2010 (KR) 10-2010-0114133

(51) Int. Cl. H04L 9/28

(52) U.S. Cl. 380/28

(57) ABSTRACT

An encryption method and apparatus for encrypting a plurality of rounds are provided. The encryption method including: extracting a conversion function, which is convertible in a table form from a predetermined block encryption method; converting the extracted conversion function into a corresponding converted table; applying the converted table to an input bit; applying an extension function, which extends an output bit, to an output of the converted table; and applying a restore function, which restores the extended output bit.

### CROSS-REFERENCE TO RELATED APPLICATION

This application claims priority from Korean Patent Application No. 10-2010-0114133, filed on Nov. 16, 2010, in the Korean Intellectual Property Office, the disclosure of which is incorporated herein by reference in its entirety.

### BACKGROUND

1. Field

Apparatuses and methods consistent with exemplary embodiments relate generally to an encryption apparatus and method, and more particularly, to an encryption apparatus and method which perform block encryption.

2. Description of the Related Art

A block encryption algorithm such as advanced encryption standard (AES), a public key encryption algorithm such as Rivest-Shamir-Adleman (RSA), and the like are initially designed without considering the safety of the environment in which the algorithm is executed. That is, an attacker checks an algorithm and various inputs and outputs, but the attacker cannot check an execution environment of the algorithm. This attack model is generally known as a “black-box model.” In one example, an encryption/decryption process is performed using an algorithm embodied in a hardware chip, which is not analyzed by the attacker, and a key may be safely built. In this example, since the safety of a system is identical to the safety of the encryption algorithm, the safety analysis is simple. However, it is known from general content protection technology hacking cases that the “black-box attack model” is not practical.

On the other hand, access for an input and output, as well as an embodied execution code and data area is allowed in the “whitebox attack model.” That is, general personal computer (PC) software is an example of the attack model. If a consumer electronics (CE) device is not specially designed based on its hardware, the CE device becomes the most practical model. The whitebox cryptography raises a question of how to presume the attack situation and how to protect the key and data.

A related art algorithm may be entirely broken by an algebraic attack having a complexity of 228 bits. That is, the algebraic attack method having a complexity of 228 bits is capable of recovering all round keys and then recovering a secret key itself

The basic reason that an attack may be achieved is because a 128-bit input is divided into four 32*32 tables to reduce the complexity from 2¹²⁸*128 to 2³²*128. Of course, it is not practical that 2³²*32=2³⁶-byte=2⁶ GB (where “GB”=gigabyte), but 2³²*32=2³⁶-byte=2⁶ GB is significantly smaller than 2^{128*}128=2¹³²-byte=2¹⁰² GB.

If the related art algorithm maintains the complexity of 2³²*32, it does not matter in practice since it is because the complexity is lowered to 2⁸*32=2¹²-byte=4 KB by dividing the 32-bit input into four 8-bit inputs and inspecting a 32-bit output for the 8-bit input. That is, when the 32-bit input is represented as four 8-bit inputs x3, ×2, x1 and x0, if one of the four 8-bit inputs x3, ×2, x1 and x0 and the remnant are set to 0 (zero), outputs for all 256 inputs are investigated to obtain an encoding function value used in the input and output. When the obtained encoding function value is removed, all those used for hiding the table representing each round of AES are invalidated and finally the clue for finding out the secret key is provided.

FIG. 1 illustrates the related art as described above. In FIG. 1, “Dec” denotes decoding for encoding of a previous round, “Enc” denotes encoding for an output of each round, and Enc is a nonlinear bijection.

However, the algebraic attack method having a complexity of 228 bits has 3 stages and has problems in that a nonlinear portion and a linear portion of an encoding added after XOR is represented as a table using the above-described characteristics and a secret key is extracted using the relationship between rounds in the first stage.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above. Additionally, one or more exemplary embodiments provide an encryption apparatus and method capable of effectively protecting a key and data.

An aspect of an exemplary embodiment provides an encryption method for encrypting a plurality of rounds, wherein the method may include: extracting a conversion function, which is convertible in a table form from a predetermined block encryption method; converting the extracted conversion function into a corresponding converted table; applying the converted table to an input bit; applying an extension function, which extends an output bit, to an output of the converted table; and applying a restore function, which restores the extended output bit.

The extension function may extend a 32-bit input into a 128-bit input and outputs the 128-bit input.

The predetermined block encryption method may be advanced encryption standard (AES).

The converting of the extracted function into the corresponding converted table may include converting at least two conversion functions, from among a plurality of conversion functions constituting at least one round of the plurality of rounds, into one table.

The extension function may be a linear extension function.

The extension function may be a nonlinear extension function and includes an operation, which adds a random bit to the extended output bit.

An aspect of an exemplary embodiment provides a present encryption apparatus for encrypting a plurality of rounds, wherein the apparatus may include: a table encryption unit which extracts a conversion function, which is convertible in a table form, from a predetermined block encryption method, converts the extracted conversion function into a corresponding converted look-up table and applies the converted look-up table to an input bit; an extension unit which extends an output bit to an output of the table encryption unit; and a restoring unit which restores the extended output bit.

The extension unit may extend a 32-bit input into a 128-bit input and outputs the 128-bit input.

The predetermined block encryption method may be advanced encryption standard (AES).

The table encryption unit may convert at least two conversion functions, from among a plurality of conversion functions constituting at least one round among the plurality of rounds, into one table.

The apparatus may further include a random bit generating unit which generates a random bit and provides the random bit to the extension unit, wherein the extension unit applies a nonlinear extension function to which the random bit is added to the output of the table encryption unit.

The extension unit may apply a linear extension function to extend the output bit to the output of the table encryption unit.

### BRIEF DESCRIPTION OF THE DRAWINGS

The above and/or other aspects will be more apparent by describing in detail exemplary embodiments, with reference to the accompanying drawings, in which:

FIG. 1 is a view illustrating the related art.

FIGS. 2A and 2B are block diagrams illustrating configurations of encryption apparatuses according to exemplary embodiments;

FIGS. 3A and 3B are views illustrating an encryption method according to an exemplary embodiment;

FIGS. 4A to 4C are views illustrating a detailed configuration of each process of the encryption method of FIG. 3A according to an exemplary embodiment;

FIGS. 5A to 5C are views illustrating an encryption method according to an exemplary embodiment;

FIGS. 6A and 6B are views illustrating an external encoding insertion method according to an exemplary embodiment;

FIG. 7 is a view illustrating an encryption method according to an exemplary embodiment; and

FIG. 8 is a view illustrating an encryption method according to an exemplary embodiment.

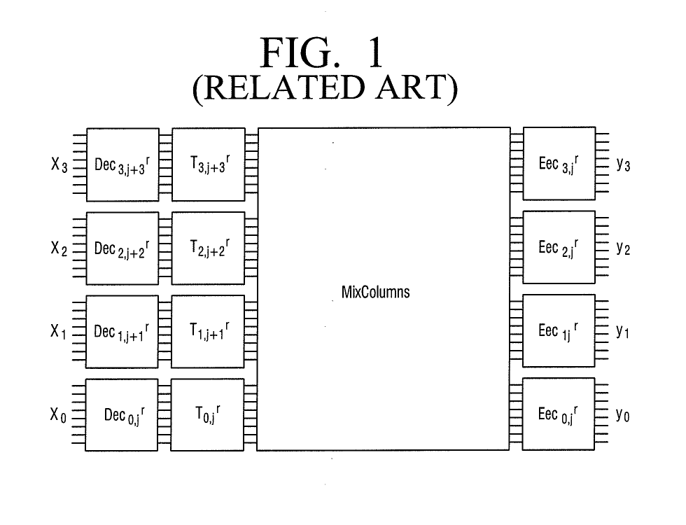

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

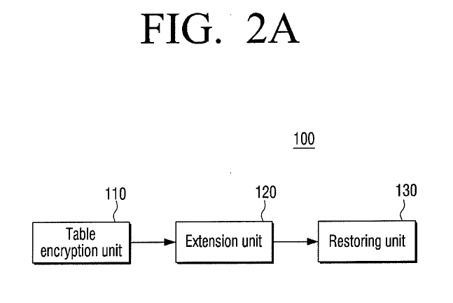

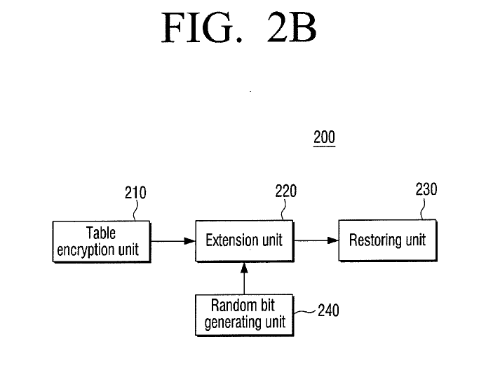

FIGS. 2A and 2B are block diagrams illustrating configurations of encryption apparatuses according to exemplary embodiments.

Referring to FIG. 2A, an encryption apparatus 100 includes a table encryption unit 110, an extension unit 120 and a restoring unit 130. The term “unit” as used herein means a hardware component and/or a software component that is executed by a hardware component such as a processor.

The encryption apparatus 100 as shown in FIG. 2A may perform encryption on the basis of a block encryption algorithm.

That is, the encryption apparatus 100 may input a plaintext of a block unit to perform encryption. Here, the plaintext means a character string which is to be encrypted.

Hereinafter, block encryption according to one exemplary embodiment will be described in brief.

The block cipher is a symmetric key cipher system which performs encryption for security information in a predetermined block unit. If information to be encoded has a longer length than a block length, a specific operation mode may be used (for example, electronic code book (ECB), cipher-block chaining (CBC), output feedback (OFB), cipher feedback (CFB), counter (CTR), or the like).

In one exemplary embodiment, a Feistel scheme and an SPN scheme may be a block cipher scheme.

The Feistel scheme has advantage in that an inverse function is unnecessary in the encryption/decryption process, but it has disadvantages in that a larger amount of operation is required due to a swap process; furthermore, a round function used for encryption should be securely designed in realizing the Feistel scheme. There is data encryption standard (DES) as a typical encryption of the Feistel scheme, but single DES is not used due to a security problem at present. The SPN scheme has a disadvantage in that it should be designed to request an inverse function in an encryption/decryption process. However, since it is possible to perform encryption once without a bit shift, it is possible to effectively design the SPN scheme as compared the Feistel scheme. Advanced encryption standard (AES) is a typical encryption of the SPN scheme. Exemplary embodiments will be described by assuming that the AES is applied as a block encryption algorithm.

In one exemplary embodiment, the table encryption unit 110 may input a plaintext of a block unit (for example, 128 bits) to perform encryption.

Specifically, the table encryption unit 110 may extract a conversion function which is convertible into a look-up table from a predetermined block encryption algorithm, convert the extracted conversion function into a corresponding look-up table, and apply the converted look-up table to an input bit. Here, the block encryption algorithm may be AES as described.

In addition, the table encryption unit 110 may convert at least two or more conversion functions of a plurality of conversion functions constituting one round into one table. For example, the table encryption unit 110 may convert conversion functions corresponding to the “AddRoundKey” and “SubBytes” step of an AES algorithm step described later into one table and apply the table to the input bit.

The extension unit 120 may apply an extension function which extends an output bit to an output of the table encryption unit 110. For example, the extension unit 120 may extend 32-bit input to a 128-bit input and output the 128-bit input.

Specially, the extension unit 120 may apply a linear extension function to the output of the table encryption unit 110.

The restoring unit 130 may apply a restore function which restores an extended output to an output of the extension unit 120.

Referring to FIG. 2B, an encryption apparatus 200 includes a table encryption unit 210, an extension unit 220, a restoring unit 230, and a random bit generating unit 240. A detailed description of portions of configuration elements of FIG. 2B which are the same as the configuration elements as illustrated in FIG. 2A will be omitted.

The table encryption unit 210 may extract a conversion function from a block encryption algorithm. The conversion function is convertible into a look up table, and the table encryption unit 210 may convert the extracted conversion function into a corresponding look-up table and apply the converted look-up table to an input bit. Here, the block encryption algorithm may be AES, as described above.

Specifically, the table encryption unit 210 may convert at least two or more conversion functions of a plurality of conversion functions constituting one round into one table.

The extension unit 220 may apply an extension function which extends an output bit to an output of the table encryption unit 210. For example, the extension unit 220 may extend a 32-bit input into a 128-bit input and outputs the 128-bit input.

In addition, the extension unit 220 may apply a nonlinear extension function to the output of the table encryption unit 210.

The restoring unit 230 may apply a restore function which restores the extended output bit into an original bit to an output of the extension unit 220.

The random bit generating unit 240 may generate a random bit and provide the random bit to the extension unit 220. In this case, the extension unit 220 may apply a nonlinear extension function to which the random bit is added to the output of the table encryption unit 210. AES Operations

Hereinafter, an encryption method of the table encryption unit 210 according to an exemplary embodiment will be described in further detail.

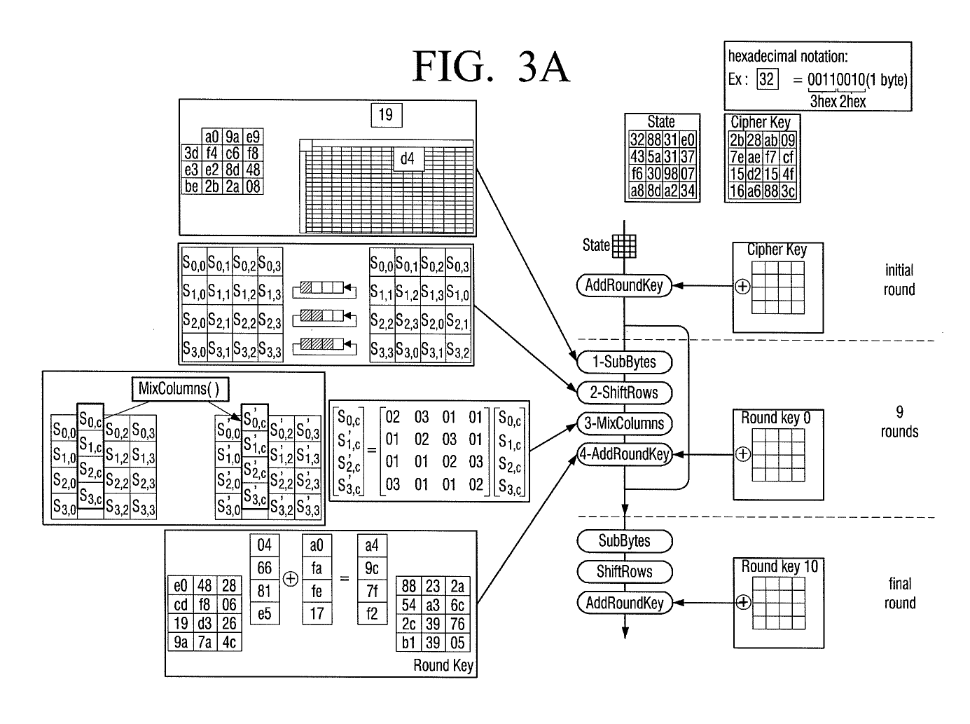

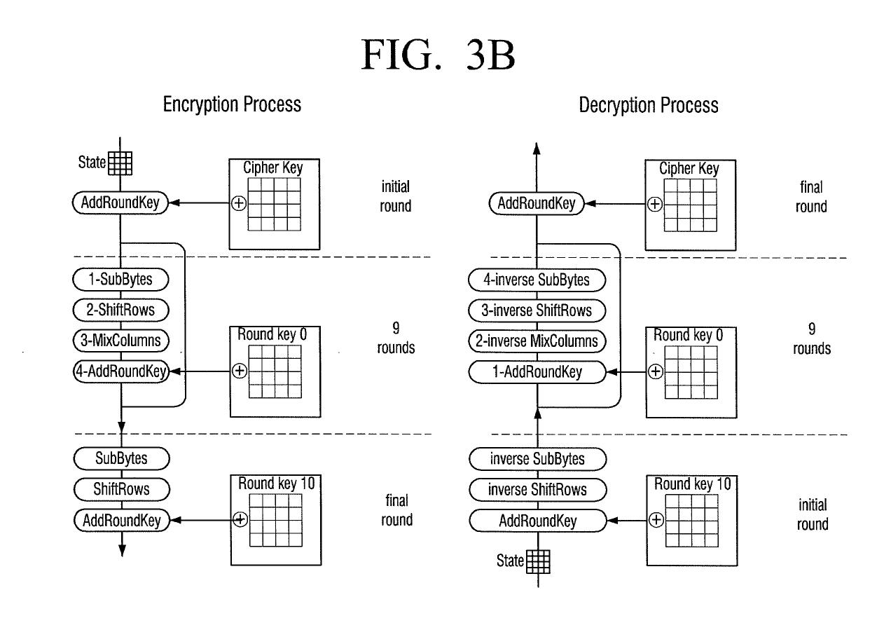

FIGS. 3A and 3B are views illustrating an encryption method according to an exemplary embodiment.

Referring to FIG. 3A, an encryption method according to an exemplary embodiment may perform encryption by applying a block encryption algorithm and for example, may perform the encryption by applying an AES algorithm as illustrated.

The AES algorithm may be constituted of eleven rounds including “initial round, 9 round and final round” as illustrated.

Here, the “initial round” may include “AddRoundKey” step which adds a cipher key to an input plaintext.

In addition, each round of the 9 rounds in which the same round is repeated 9 times may include a “1-SubBytes” step for substituting a key for a block in which the initial round is performed using a table, a “2-ShiftRows” step for shifting a row, a “3-MixColumns” step for mixing a column, a “4-initial round(AddRoundKey??)” step for adding a round key. That is, the “1-SubBytes” step, the “2-ShiftRows” step, the “3-MixColumns” step and the “4-initial round(AddRoundKey??)” step may be repeatedly performed 9 times.

In addition, the final round may perform the “SubBytes” step, the “ShiftRows” step and the “AddRoundKey” key.

Referring to FIG. 3B, a decryption process corresponding to the encryption process as illustrated in FIG. 3A is illustrated.

The decryption process may perform the steps of the encryption process in reverse order as illustrated.

### Basic Idea of White Box AES

Step 1: Each round of AES may be encoded in a look-up table as the following Equation 1 and separated into indicated different configuration element into each other.

X₁° X₂° . . . ° Xᵢ [Equation 1]

Step 2: Bijections M1, M2 may be randomly selected and inserted around the different configuration elements as the following Equation 2 separated in the Step 1 according to inverses thereof.

M₁⁻¹° M₁° X₁° M₂° M₂⁻¹° M₃⁻¹° M₃° X₂° M_{4°} M₄⁻¹° . . . ° M₂ᵢ₋₁⁻¹° M₂ᵢ₋₁° Xᵢ° M₂ᵢ° M₂ᵢ⁻¹ [Equation 2]

Step 3: Parts generated in the Step 2 may be grouped in a predetermined form as the following Equation 3, each group may be input to the separated table, and two mapping F⁻¹ and G may be input around the separated group.

F₁⁻¹° M₁⁻¹° M₁° X₁M₂° M₂⁻¹° M₃⁻¹° M₃° X₂° M_{4°} M₄⁻¹° . . . ° M₂ᵢ₋₁⁻¹° M₂ᵢ₋₁° Xᵢ° M₂ᵢ° M₂ᵢ⁻¹° G [Equation 3]

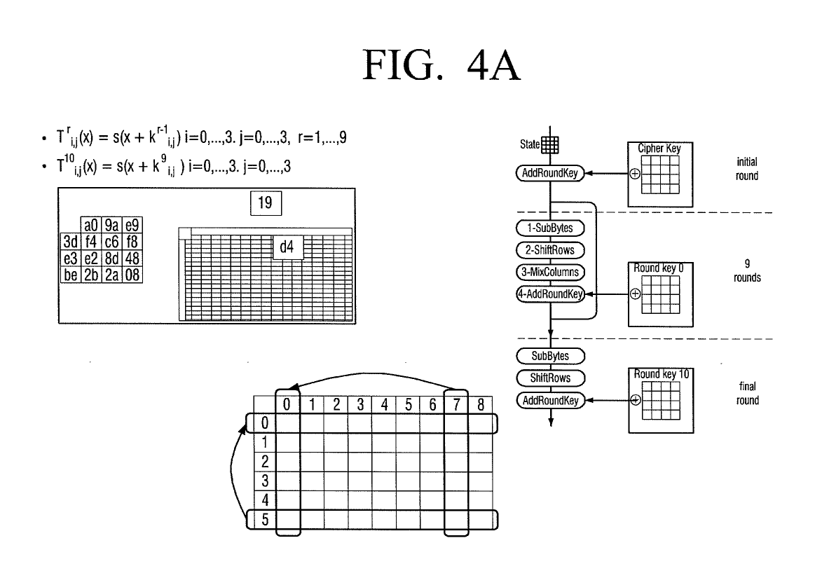

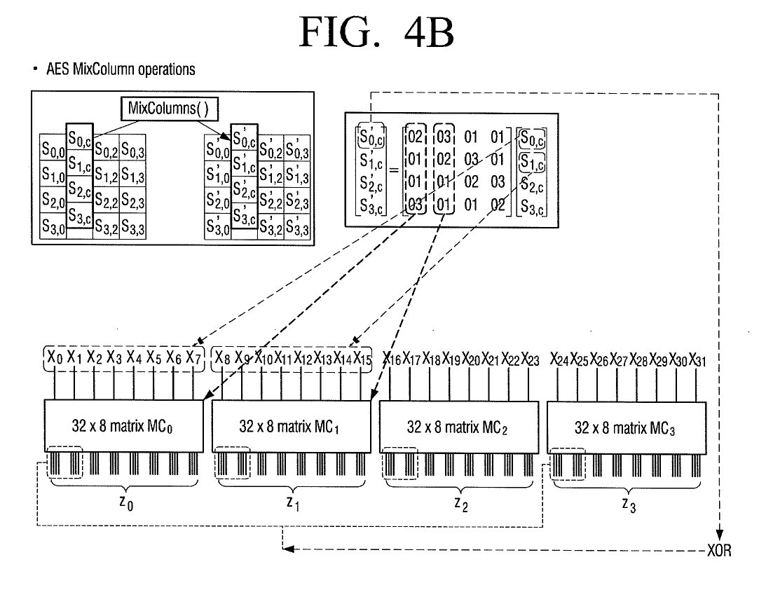

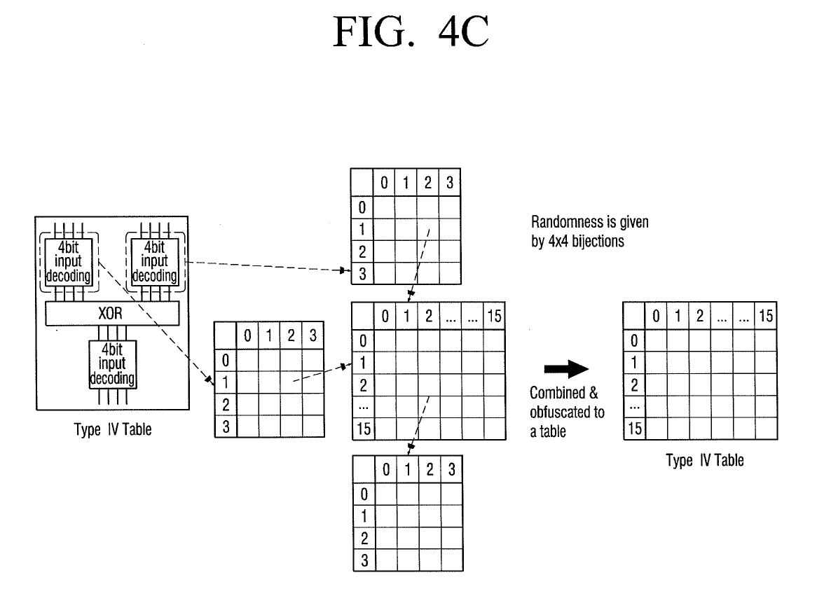

FIGS. 4A to 4C are views illustrating a detailed configuration of each Step in the encryption process as illustrated in FIG. 3A.

### Hiding the Key in S-Boxes

FIG. 4A is a view illustrating a configuration of 1-SubBytes step of the encryption process as illustrated in FIG. 3A.

Referring to FIG. 4A, a key substitution operation for a target block in which the initial round is performed may be performed using “S-box” in the 1-SubBytes step.

In addition, the operation of the “AddRoundKey” step and the configuration of “1-SubBytes” step which are performed the initial round may be embodied by one table, that is, “T-box”.

T_{i,j}^{r}(x)=S(x+k_{i,j}^{r-1})i=0, . . . , 3,j=0, . . . , 3,r=1, . . . , 9

T_{i,j}¹⁰(x)=S(x+k_{i,j}⁹)i=0, . . . , 3,j=0, . . . , 3 [Equation 4]

For example, if k={01010111}₂ or {57}ₕ, it becomes T({00}ₕ)=S({57}ₕ) so that the T-box is as illustrated in a left-lower part of FIG. 4A.

In general, it becomes 10*16=160 T-boxes which is 8*8 tables (8-bit input, 8-bit output).

### MixColumns

FIG. 4B is a view illustrating a configuration of the MixColumns step of the encryption process as illustrated in FIG. 3A.

Referring to FIG. 4B, an operation for mixing columns for a target block in which the 2-ShiftRows step is performed may be performed in the MixColumns step.

If the AES MixColumns operation is indicated as a look-up table such as S-box, since the look-up table has a 32-bit input and a 32-bit output, the look-up table has a cost of 2¹⁶×2¹⁶×32=16 GB.

Accordingly, MC is blocked in four 32×8 sections as illustrated.

In this case, all four tables have a cost of 4×2^{8×32=4} KB.

On the other hand, the “2-ShiftRows” step is an operation for shifting a row as illustrated in FIG. 3A and detailed description thereof will be omitted.

### XOR-Type IV Table

FIG. 4C is a view illustrating a method of applying a random function according to an exemplary embodiment.

Referring to FIG. 4C, a bijection function may be randomly selected and the randomly selected bijection function may be applied together with an inverse thereof. Accordingly, although an intermediate value during an encryption process is varied, a result value of the encryption process has the same value as that before the randomly selected bijection function is applied.

XOR may be performed for sub-divided 4-bits so as to reduce a size of a XOR table. Accordingly, it becomes 24 (8 4-bits for each Zᵢ, 3-XOR) 4-bit XORs. Here, XOR may be an 8 (4-bits, 4-bit input)×4(4-bit output) tables.

In addition, as illustrated, nonlinear random 4×4 bijections may be input around the XOR table as an input encoding and output encoding.

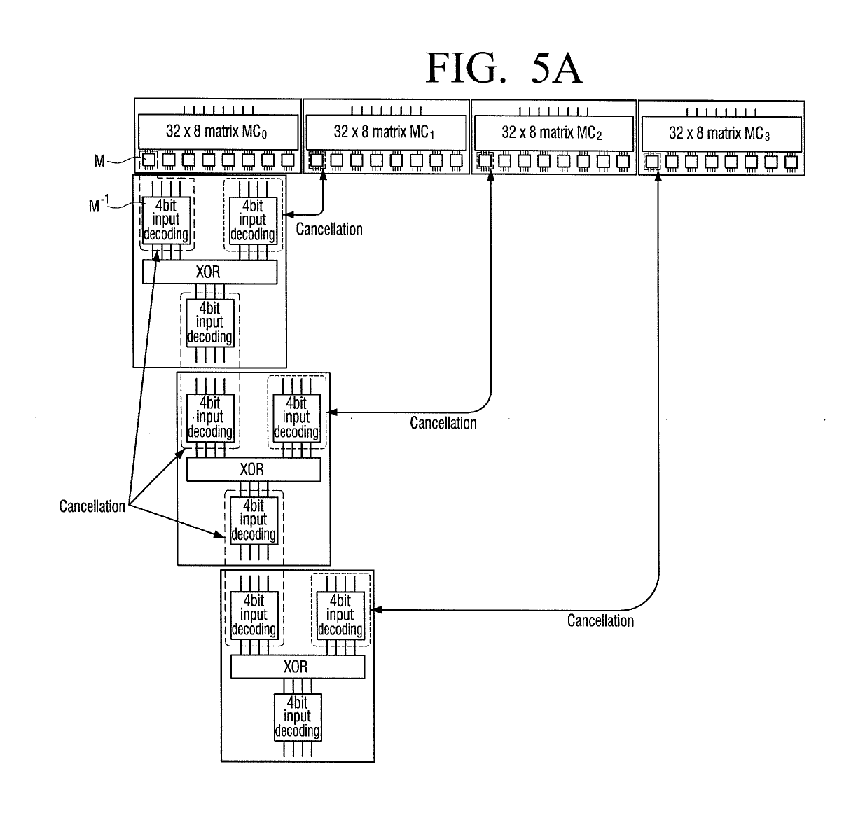

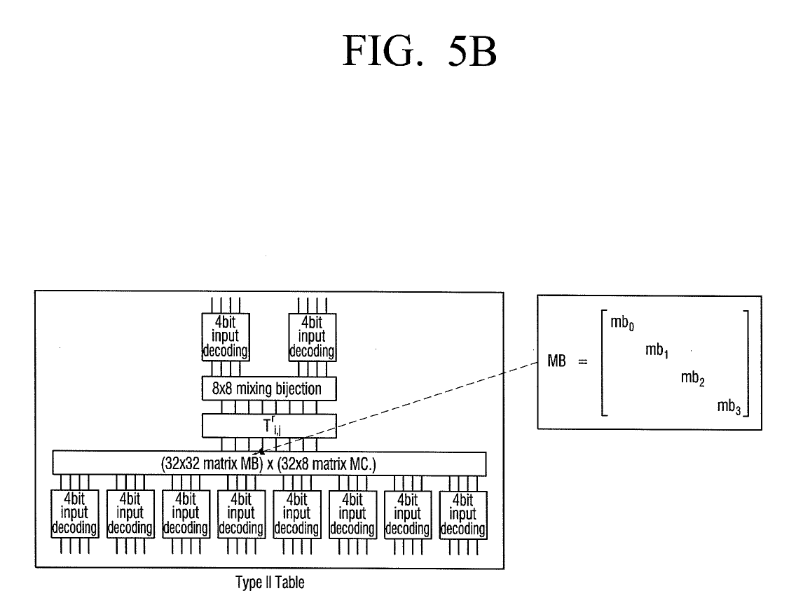

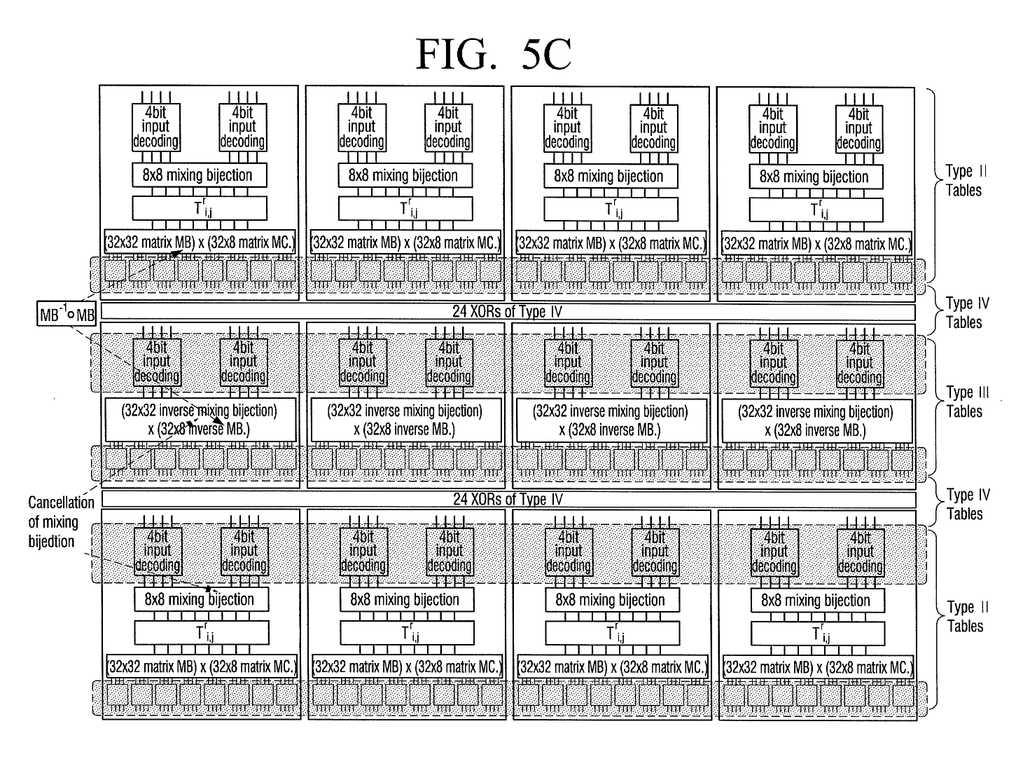

FIGS. 5A to 5C are views illustrating an encryption method according to an exemplary embodiment.

FIG. 5A illustrates a method of inserting a mixing bijection after MiXColumns and XOR steps.

Referring to FIG. 5A, 24 type IV tables are required for one MiXColumns operation of a 32-bit input and a 32-bit output.

FIGS. 5B and 5C are views illustrating a method of constituting T-box and Mixcolumns according to an exemplary embodiment.

Referring to FIG. 5B, it may constitute 8*32 tables of the T-boxes (SubBytes and AddRoundKey) and Mixcolumns so as to save a space and time without separating T-box and Mixcolumns.

In this case, the mixing bijection may be defined as a T-box input so as to distribute the T-box input.

On the other hand, a 32*32 mixing bijection as a nonsingular matrix having 4*4 submatrix are multiplied in a left part of MC (MixColumn) so as to confuse the MixingColumns operation.

It is for erasing the 8*8 mixing bijection by the T-box input in next round.

Referring to FIG. 5C, Type III tables are defined so as to invalidate and confuse the mixing operation of T-box and MixColumns.

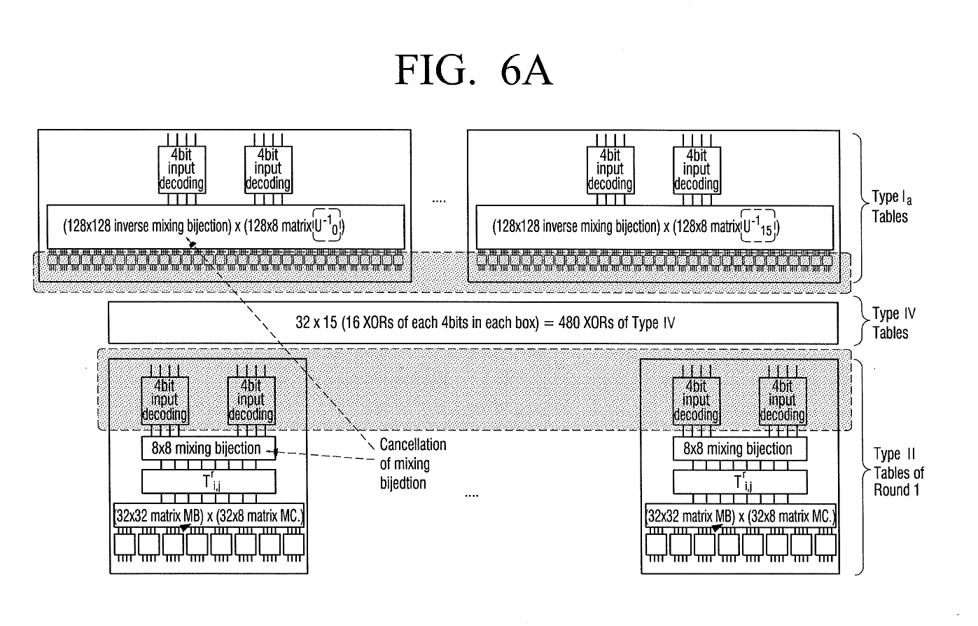

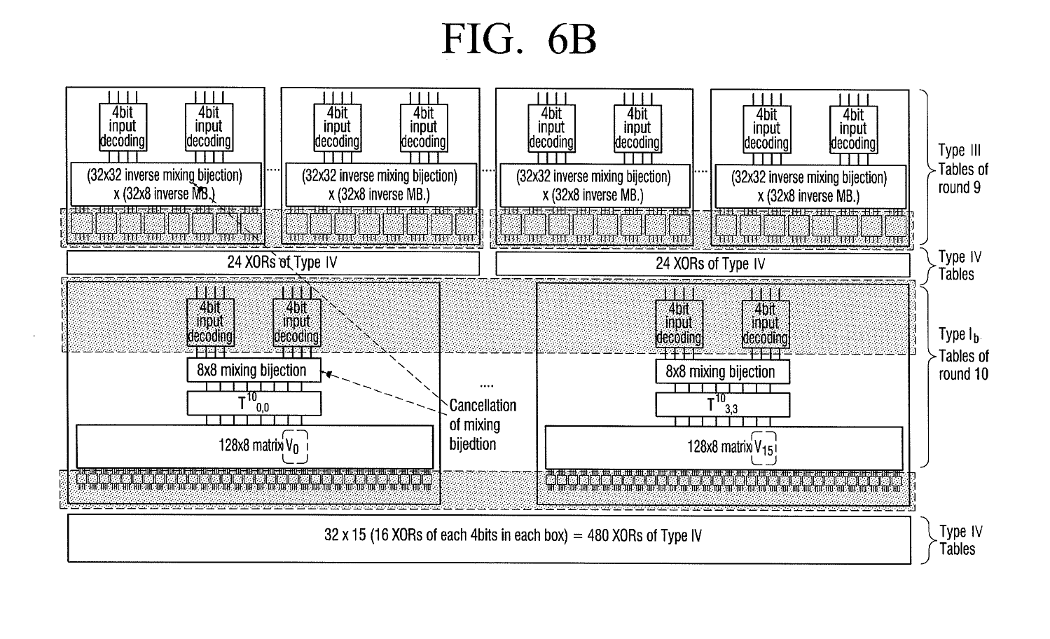

FIGS. 6A to 6C are views illustrating a method of inserting external encoding according to an exemplary embodiment.

Referring to FIGS. 6A and 6B, two encoding functions F¹ (U⁻¹) and G(V) may be applied to protect an input and output of MB. The two encoding functions F⁻¹ (U⁻¹) and G(V) may be selectively applied.

Here, U⁻¹ V is a 128*128 linear bijection constituting of 1024(32*32) of 1024(32*32) 4*4 submatrices and randomly selected.

Hereinafter, encryption methods according to exemplary embodiments will be described.

### First Embodiment

According to a first exemplary embodiment, a method of regarding the block function itself as one table may be used other than a method of making each function constituting a block cipher as a table and synthesizing the tables.

In detail, a method of extending an 8-bit unit into a 16-bit or more unit to increase attack quantity may be considered. However, a size of the table required to represent the conversion function as a table is exponentially increased due to this.

For example, if an 8-bit unit input is extended into a 32-bit unit input, a size of one table required becomes 64 GB. Extremely, a size of the table required to represent the conversion function having a 128-bit input becomes 2¹⁰² GB.

Accordingly, in the first exemplary embodiment, so as to prevent a size of the table from increase exponentially and to prevent a secret key and a table from restoring, a method of representing all rounds of a block cipher as one table by reducing an input length to a smaller unit than the 128-bit input, adding a predetermined padding to a reduced input to extend the reduced input into a 128-bit input again, applying all rounds of the block cipher to the input, and outputting each output with concatenation.

In this case, the table for all rounds of the block cipher is a table which is made under the consideration of a secret key to be hidden. For example, it is assumed that the block cipher is applied in a separated 16-bit unit, an arbitrary key having a 128-bit length of the block cipher is k, and an arbitrary input message having a 128-bit length is M.

Since the block cipher is a 16-bit unit, the input message is divided into eight. If it is assumed that an encryption algorithm of the block cipher is E(k,M) and a decryption algorithm is D(k,C), Encryption and decryption tables for the 16-bit input for the key k are provided. Here, the total number of inputs is 2¹⁶, so that E(k,M) may be applied to all cases to create a encryption table. Since E(k,M) encodes the 128-bit input, it may concatenate an 112-bit arbitrary padding with the 16-bit input to set the concatenated 128-bit input as an input of E(k,M).

It is assumed that 2¹⁶ messages are m₁, . . . , m₆₅₅₃₆, respectively. First, a method of obtaining from an output c₁=E(k,m₁) using m₁ as an input of an encryption table to c₆₅₅₃₆=E(k,m₆₅₅₃₆) using m₆₅₅₃₆ as an input of an encryption table is performed and the obtained c₁=E(k,m₁) to c₆₅₅₃₆=E(k,m₆₅₅₃₆) are used as the encryption table. The encryption table is referred to as E-TBLₖ(M). An decryption table may be a table in which the input and the ouput of the encryption table are changed to each other and is referred to as D-TBLₖ(C).

So as to encode the input message M, the input is divided into a 16-bit unit to obtain M₁, . . . , M₈ and the encryption table is applied to each of the obtained M₁, . . . , M₈. Here, since all M₁, . . . , M₈ have a 16-bit value, the M₁, . . . , M₈ are included in all cases of the above obtained encryption table so that a desired cipher text for any message can be obtained. If it is assumed that the cipher texts are C₁=E-TBLₖ(M₁), . . . , C₈=E-TBLₖ(M₈), the output of the Whitebox block cipher according to the exemplary embodiment is C=C₁∥ . . . ∥C₈.

The decryption process provides only the decryption table to an algorithm required to a host appliance. Since an output of E-TBLₖ(M) is 128-bits, an input of the decryption table becomes 128-bits and an attacker is impossible to restore the table. In addition, the cipher text represents the all rounds of the cipher block as a table, so that the safety for a secret key of a given block cipher is completely identical with that of the secret key of the block cipher embodied as the Whitebox according to the exemplary embodiment.

### Second Embodiment

In another exemplary embodiment, a method of synthesizing an extension function with a given block encryption algorithm and a method of randomizing a created table are used.

In the related art, since 16 tables having the 8-bit input and the 32-bit output are considered, the size of the table can be reduced, but if only one 8×32 table is considered, the attack quantity is drastically reduced as attacked by the algebraic attack having a complexity of 228 bits, or the like. So as to compensate the disadvantage, this exemplary embodiment converts a block encryption algorithm constituting one round into one table (referred to as “T-Box,” for example, it may be represented as T-Box=MC(SB(AR(SR(x),SR(k))).) and applies a expansion algorithm (hereinafter, referred to as “E”) which expands an output of the T-box to a size of an output value of the block cipher.

In the case of AES, T-box has an 8-bit value as an input to output a 32-bit value and an output of T-Box is expanded to 128-bits again by the expansion algorithm E. Next, an XOR operation for the one round performed by applying an algorithm which restores 32-bits from the 128-bits. The XOR operation is performed by the number of rounds required by the given block encryption algorithm. At this time, contents of tables of the respective rounds are different from each other.

128×32 matrix is considered as an example of the extension function. It is assumed that if Q₁, Q₂, Q₃, and Q₄ are 32×32 matrix having an inverse matrix, Q₁, Q₂, Q₃, and Q₄ are Qᵢ∈GL₃₂(F₂). If Qᵢ is regarded as permutation on 32-bits, then E:=^{t}(Q₁Q₂Q₃Q₄). After T-Box is applied to an input x⁽ⁱ⁾, 1≦i≦16, 32-bit permutation is applied, and the operation for obtaining 128-bits is E=T-Box(x⁽ⁱ⁾) and is represented as g₁ . . . g₁₂₈. An inverse matrix of E is considered to extract the original 32-bits from the value. In the exemplary embodiments, it is referred to as a restore function (or recovery function).

The restore function may be also represented as a matrix and in this case, the restore function is 32×128 matrix. Specifically, it should be Pᵢ·Qᵢ=I₃₂ for 1≦i≦4. Here, I₃₂ denotes 32×32 identity matrix. If a matrix is considered on F₂, one of Pᵢ should be a null matrix and the recovery function may be represented as D=(P₁P₂P₃P₄).

### Third Embodiment

In a third exemplary embodiment, a method of randomizing a table to prevent the table for each function constituting a block cipher from recovering is used.

This embodiment may be capable of recovering the table through an input/output attack for a given table since there is one encryption/decryption table for a given function.

First, it is assumed that the table for the given function of the related art is equal to the following Table 1.

TABLE 1

| Ciphertext c | Plaintext p |
|---|---|
| C₁ | P₁ |

. . .

| | |
|---|---|
| C₆₅₅₃₆ | P₆₅₅₃₆ |

That is, a decryption table having total 2¹⁶ entries for a 16-bit input value is considered. When an algorithm A which provides an output by providing an input even though a content of the table is not revealed is considered, if a length of the input is short, for example, the outputs for all inputs can be collected 2¹⁶ times to recover the table entirely recovered even though the content of the table is hidden. This exemplary embodiment uses a method of converting the input and the output and dividing the table into a plurality of tables to prevent the attack.

A first method according to this exemplary embodiment is to convert the input and the output into a form as the following Table 2 by applying an arbitrary function h( ) in which a collusion pair occurs less such as a cryptographic hash function.

TABLE 2

| h(c) | m |
|---|---|
| 00000000000000010 | m_{1, 1} m_{1, 2} . . . m_{1, 16} |
| 00000000000000011 | m_{2, 1} m_{2, 2} . . . m_{2, 16} |
| 0000000000000010 | m_{3, 1} m_{3, 2}. . . m_{3, 16} |
| . | . |
| . | . |
| . | . |
| 011111111111111111 | m_{65536, 1} m_{65536, 2} . . . m_{65536, 16} |

However, if the function h( ) has been revealed, after applying h( ) to an arbitrary input, it is possible to check the result, so that the method of converting the output value is also used to prevent the output value for the given input from recovering. If a function for converting the output value is regarded as g, the above table is stored by including the entry as the following Table 3.

TABLE 3

| h(c) | g(m) |
|---|---|
| 00000000000000010 | g(m_{1, 1} m_{1, 2} . . . m_{1, 16}) |
| 00000000000000011 | g(m_{2, 1} m_{2, 2} . . . m_{2, 16}) |
| 0000000000000010 | g(m_{3, 1} m_{3, 2} . . . m_{3, 16}) |
| . | . |
| . | . |
| . | . |
| 011111111111111111 | g(m_{65536, 1} m_{65536, 2} . . . m_{65536, 16} |

According to this, although an attacker grasps the output for the input value, since the attacker does not know the original output value for the input, the recovery for the table due to the input/output attack can be protected.

In this exemplary embodiment, a method of changing a table entry using a random value r=(r₁, . . . , rₙ), dividing the table to store the divided table, and providing the output for the input by referring the table several times is used to provide better safety. So as to describe the method in detail, the following is defined.

g: {0,1}¹⁶→{0,1}¹⁶ is defined as following.

G(c,m,r)=(A° M(m+r))⊕f(r,c).

M (m+r)=^{T}(m₁+r₁, m₂+r₂, . . . , m₆₅₅₃₆+r₆₅₅₃₆)∈2^{16×1} GF(2¹⁶) matrix

A∈2¹⁶×2¹⁶ GF(2) reversible sparse matrix

f: {0,1}¹⁶×{0,1}¹²⁸→{0,1}¹⁶ one-way function.

f′: {0,1}¹²⁸→{0,1}¹⁶ one-way function.

The following equations 4 and 5 can be obtained by applying those to Table 3.

TABLE 4
separated table #1

| h(c) | m r | A° M(m′) | Output |
|---|---|---|---|
| c1 | m′1 = m1 + r1 | a1 | a1⊕f(r1, c1) |
| c2 | m′2 = m2 + r2 | a2 | a2⊕f(r2, c2) |
| c3 | m′3 = m3 + r3 | a3 | a3⊕f(r3, c3) |
| . . . | . . . | . . . | |
| c65536 | m′65536 | a65536 | a65536⊕f(r65536, c65536) |

TABLE 5
separated table #2

| h(c) | R | A° M(r) | Output |
|---|---|---|---|
| c1 | r1 | a′1 | a′1⊕f′(r1, c1) |
| c2 | r2 | a′2 | a′2⊕f′(r2, c2) |
| c3 | r3 | a′3 | a′3⊕f′(r3, c3) |
| . . . | . . . | . . . | |
| c65536 | r65536 | a′65536 | a′65536⊕f′(r65536, c65536) |

A method of calculating an output corresponding to an input using the same is as follows.

1. Calculate f′(cᵢ) using the ciphertext cᵢ in Table 5 to obtain aᵢ′.

2. Recovery rᵢ using aᵢ′ and matrix A⁻¹.

3. Calculate f(rᵢ,cᵢ) using rᵢ and a ciphertext cᵢ in Table 4 to obtain aᵢ.

Recover mᵢ′ using a, and matrix A⁻¹.

5. Plaintext mᵢ=mᵢ⊕rᵢ.

By the above method, the same result as that in the method of storing only one table is safely obtained without converting the original input and output.

In addition, the method of creating many random number r to extend the table by the number of random numbers used, thereby to obtain better safety.

### Fourth Embodiment

In the second exemplary embodiment, a linear function is used as the extension function, but a nonlinear function is exemplified as an extension function to enhance the safety in this exemplary embodiment, and a recovery function and an exclusive OR (XOR) operation process corresponding to the nonlinear function will be described.

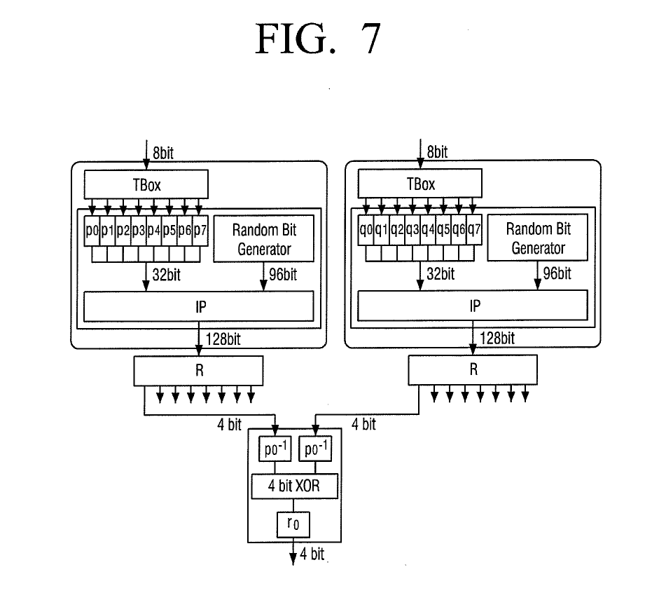

FIG. 7 is a view illustrating an encryption method according to an exemplary embodiment.

Referring to FIG. 7, a 32-bit output of T-box having an 8-bit input and the 32-bit output is divided into 8 4-bit outputs and encoded into eight 4-bit bijection functions arbitrarily selected pᵢ, i=0, 1, 2, 3, 4, 5, 6, 7. The 32-bit output as described output is concatenated with a 96-bit output arbitrarily selected to provide a 128-bit output. A bit position of 128-bits is changed using 7-bit bijection function f arbitrarily selected again (IP (index permutation) in FIG. 7). The nonlinear extension function may be configured as the above manner and the T-Box and the nonlinear extension function are synthesized to form a table having an 8-bit input and a 128-bit output.

Next, the 128-bit output may be recovered to the original 32-bit output using information of a function value f(i), i=0, 1, . . . , 31 of the 7-bit bijection function f which is used for changing the bit position as described above (In FIG. 7, R is a recovery function).

Since the recovered 32-bit output is encoded into eight 4-bit bijection functions, the 32-bit output is divided into eight 4-bit outputs and then decoded to perform the XOR operation.

Accordingly, the XOR operation is divided in a 4-bit unit and two 4-bit encoding are added to the input and one 8-bit encoding is added to the output to form one table having the 8-bit input and the 4-bit input. r₀ is an arbitrary nonlinear encoding for an output of XOR.

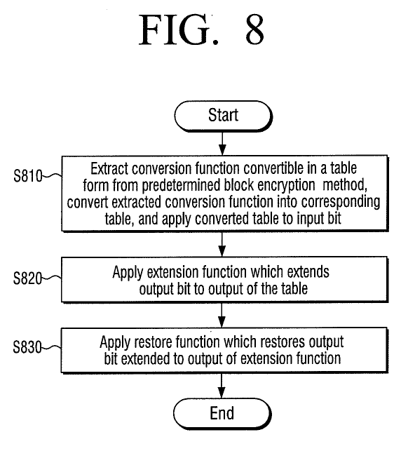

FIG. 8 is a flow chart illustrating an encryption method according to an exemplary embodiment.

Referring to FIG. 8, the encryption method according to an exemplary embodiment is an encryption method performing encryption for a plurality of rounds. First, a conversion function which is convertible in a table form is extracted from a predetermined block encryption algorithm, the extracted conversion function is converted to a corresponding table, and the converted table is applied to an input bit (S810). Here, the block encryption algorithm may be AES.

An extension function for extending an output bit is applied to an output of the table which applied to the input bit (S820). Here, the extension function may be a function which extends a 32-bit input into a 128-bit input.

In addition, the extension function may be a linear function.

Alternatively, the extension function may be a nonlinear function and include an operation which adds a random bit to the extended output bit.

A restore function which restores the extended output bit is applied to an output of the extension function (S830). In addition, the converting the conversion function in a table form may include converting at least two or more conversion functions of a plurality of conversion functions constituting at least one round of a plurality of rounds into one table.

Specifically, according to the exemplary embodiment, functions of all rounds of a given block cipher are converted into tables having a smaller unit than an input bit as an input unit and outputs obtained by being applied to the table in which an input value is divided into a size of a given unit and converted are concatenated to be output as a final cipher text.

Thus, decryption process is converted into a table by applying an inverse process for functions of all rounds of the given block cipher and an output is selected by a given length from the output obtained by dividing a cipher text in which a plurality of cipher texts are concatenated and then applying the divided output to the table and concatenated, thereby recovering the plaintext.

In addition, according to another exemplary embodiment, each round is represented as sixteen 8*32 tables other than four 8*32 tables obtained by synthesizing conversion functions of all rounds and a method of representing the table using a function for extending the 32-bit input into a 128-bit input and a method of encoding the given plaintext using the table are used through the same method.

According to this, the given cipher text can be decoded reusing the table used in encoding.

In addition, according to another exemplary embodiment, an input and output of the table may be stored using a bijection function to prevent the recovery of the table without directly storing the input and output of the table.

In this case, the output of the table is randomized by applying a random number and the table is converted by the number of random numbers as a parameter and then stored.

According to another exemplary embodiment, the output of the table may be encoded by a nonlinear function and a nonlinear function mixing using a random bit may be used to obscure the attack for the table having an 8-bit input and the 128-bit output.

Thus, an operation for changing a position of a bit may be used in the extension function to allow a nonlinear encoding included in the extension function to remain in 32-bit output recovered through a recovery function.

According to the exemplary embodiment, a method of dividing an input and applying a block cipher, a method of converting a plurality of round in a batch into a table, and a method of allowing the table to be slightly expanded in a size are applied to enhance safety for the algebraic attack suggested by the algebraic attack method having a complexity of 228 bits.

The foregoing exemplary embodiments are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An encryption method for encrypting a plurality of rounds, the method comprising:
extracting a conversion function, which is convertible in a table form from a predetermined block encryption method;
converting the extracted conversion function into a corresponding converted table;
applying the converted table to an input bit;
applying an extension function, which extends an output bit, to an output of the converted table; and
applying a restore function, which restores the extended output bit.

2. The method as claimed in claim 1, wherein the extension function extends a 32-bit input into a 128-bit input and outputs the 128-bit input.

3. The method as claimed in claim 1, wherein the predetermined block encryption method is advanced encryption standard (AES).

4. The method as claimed in claim 1, wherein the converting of the extracted function into the corresponding converted table includes converting at least two conversion functions, from among a plurality of conversion functions constituting at least one round of the plurality of rounds, into one table.

5. The method as claimed in claim 1, wherein the extension function is a linear extension function.

6. The method as claimed in claim 1, wherein the extension function is a nonlinear extension function and includes an operation, which adds a random bit to the extended output bit.

7. An encryption apparatus for encrypting a plurality of rounds, the apparatus comprising:
a table encryption unit which extracts a conversion function, which is convertible in a table form, from a predetermined block encryption method, converts the extracted conversion function into a corresponding converted look-up table and applies the converted look-up table to an input bit;
an extension unit which extends an output bit to an output of the table encryption unit; and
a restoring unit which restores the extended output bit.

8. The apparatus as claimed in claim 7, wherein the extension unit extends a 32-bit input into a 128-bit input and outputs the 128-bit input.

9. The apparatus as claimed in claim 7, wherein the predetermined block encryption method is advanced encryption standard (AES).

10. The apparatus as claimed in claim 7, wherein the table encryption unit converts at least two conversion functions, from among a plurality of conversion functions constituting at least one round among the plurality of rounds, into one table.

11. The apparatus as claimed in claim 7, further comprising a random bit generating unit which generates a random bit and provides the random bit to the extension unit,
wherein the extension unit applies a nonlinear extension function to which the random bit is added to the output of the table encryption unit.

12. The apparatus as claimed in claim 7, wherein the extension unit applies a linear extension function to extend the output bit to the output of the table encryption unit.
